(19) United States
(12) Patent Application Publication
(10) Pub. No.: US 2015/0094113 A1
(43) Pub. Date: Apr. 2, 2015

(54) METHODS USED IN TELECOMMUNICATIONS SYSTEM HAVING EARLY TERMINATION CAPABILITY

(71) Applicant: MEDIATEK INC., Hsin-Chu (TW)

(72) Inventor: Xiu-Sheng Li, Hsinchu City (TW)

(73) Assignee: MEDIATEK INC., Hsin-Chu (TW)

(21) Appl. No.: 14/283,228

(22) Filed: May 21, 2014

Related U.S. Application Data
(60) Provisional application No. 61/883,348, filed on Sep. 27, 2013.

(51) Int. Cl. H04W 52/22; H04W 52/24; H04W 52/48

(52) U.S. Cl. CPC H04W 52/228; H04W 52/48; H04W 52/241
USPC 455/522

(57) ABSTRACT

Disclosed herein are various embodiments of methods to avoid abnormal transmit power control (TPC) behaviors occurring in a telecommunications system. Disclosed embodiments reduces the probability of misjudging an early termination indicator to avoid a telecommunications device from deriving improper TPC commands or alleviates the influence caused by improperly power control when a telecommunications device derives improper TPC commands.

### CROSS REFERENCE TO RELATED APPLICATIONS

This application claims the benefit of U.S. provisional application No. 61/883,348, filed on Sep. 27, 2013 and incorporated herein by reference.

### BACKGROUND

The present invention relates to telecommunications, and more particular, to methods used to avoid abnormal transmit power control behaviors in a telecommunications system having early termination capability.

Due to frequent noises and unreliability, some symbol redundancy techniques are used to guard against errors in signals transmitted between telecommunications devices. In a Wideband Code Division Multiple Access (WCDMA) system, fractional-rate symbol encoding appends error correction codes to information bits when encoding symbols. This technique allows precise recovery of the information bits if the information bits are interfered during the transmission. However, this technique disadvantageously reduces the system capacity due to the redundancy.

In order to keep merits of symbol redundancy as well as improve the system capacity, a mechanism named “early termination” is developed. Under such mechanism, a first telecommunications device is allowed to cease a transmission of a second telecommunications device before the first telecommunications device fully receives data bits contained in a data block transmitted from the second telecommunications device. Due to redundancy, it is possible for the first telecommunications device to successfully decode the received bits to derive the content of the whole data block. When this happens, the first telecommunications device can advise the second telecommunications device not to transmit remaining bits of the data block and ask the second telecommunications device to cease the transmission of the data block, thereby saving power and improving the system capacity.

The first telecommunications device sends an early termination indicator to the second telecommunications device based on a result of decoding attempt (i.e., decoding prior to receiving all of the bits contained in the data block). If the decoding attempt is successful, the first telecommunications device sends a positive early termination indicator to the second telecommunications device, which ask the second telecommunications device not to transmit the remaining part of the data block; otherwise, the first telecommunications device sends a negative early termination indicator and the second telecommunications device continually transmits remaining part of the data block to the first telecommunications device.

In a WCDMA system, a user equipment (UE) communicates with a Node B via physical channels. Physical channel includes dedicated physical channels and common physical channel. The dedicated physical channels (DPCH) further includes a dedicated physical data channel (DPDCH) and a dedicated physical control channel (DPCCH). The DPDCH is thus a physical channel used for transmitting payload data and the DPCCH is a physical channel used for transmitting control data. The control data includes reference symbols used on reception for estimating the transmission channel (coherent demodulation), power control symbols, and symbols for indicating the current transmission rate in use on the DPDCH, for example.

Basically, physical channels consist of radio frames and time slots. Time slot is a unit, which consists of fields containing bits. There are transmit power control (TPC) fields of each time slots of a downlink (DL) DPCCH and a uplink (UL) DPCCH, which is used to transmit a TPC command to allow a command receiver to conduct power control, adjusting its transmit power. In some designs, a rate of transmitting TPC command can be reduced to lower than it is originally designed. This is intended for the increasing of the system capacity. As the TPC rate is reduced, TPC fields do not have to be used every time slot. Therefore, some of them can be used to transmit the above-mentioned early termination indicators.

Please refer to FIG. 1, which schematically illustrates how the early termination mechanism works over time slots in a WCDMA system. For the sake of brevity, there are only certain fields in a time slot has been illustrated, while the other fields are omitted in the diagram. In addition, one TPC field of every two time slot is assumed to transmit the TPC command, while the other is assumed to transmit an early termination indicator. As shown by the diagram, the UE attempts to decode received data bits that are transmitted over time slots 0-12 within a transmission time interval (TTI) on the DL DPDCH, and successfully decodes them. Then, in the time slot 13 of the UL DPCCH, the UE sends a positive early termination indicator (designated with capital letter “A”) in the TPC field, to inform the Node B of stopping DL data transmission, and terminating the DL DPDCH. The Node B accordingly stops the DL data transmission over the DL DPDCH after the time slot 15 of the DL DPDCH. At this time, as the UL data has not been successfully decoded, the Node B still transmits the TPC command to adjust the transmit power of the UE, and the negative early termination indicator (designated with capital letter “N”). When the Node B successfully decodes received data bits that are transmitted over the time slots 0-17 of the UL DPDCH, the Node B sends a positive early termination indicator to the UE with the TPC field in the time slot 19 of the DL DPCCH, to stop the UL data transmission and asks the UE to terminate the UL DPDCH. As both the UE and the Node B successfully decode DL and UL data, there is no need to transmit control information on the UL DPCCH and the DL DPCCH, and the UL DPCCH and the DL DPCCH will be terminated. For the UE, as long as it detects a positive early termination indicator from the Node B and also has sent a positive early termination indicator to Node B due to a successful decoding attempt prior to receiving all parts of a DL data, it terminates the UL DPCCH. For the Node B, as long as it detects a positive early termination indicator from the UE and also has sent a positive early termination indicator to UE due to a successful decoding attempt prior to receiving all parts of a UL data, it terminates the DL DPCCH. Therefore, the system capacity is improved.

However, in such designs, once one of the Node B and the UE misjudges the early termination indicator, an “abnormal TPC period” will be introduced to the Node B or the UE. Please refer to FIG. 2, which schematically illustrates how the abnormal TPC period occurs. As shown by the diagram, in the time slot 13 of the UL DPCCH, the UE sends a positive early termination to the Node B due to a successful decoding attempt and the DL DPDCH is therefore terminated. After certain number of time slots, the Node B also successfully decodes the received data bits, and the Node B sends a positive early termination indicator to the UE in the time slot 19 of the DL DPCCH. Accordingly, the Node B terminates the DL DPCCH as the Node B deems that both of UL data and DL data have been successfully decoded. Unfortunately, the UE misjudges the positive early termination indicator as a negative early termination indicator (designated with “A->N”). Therefore, the UE still transmits a remaining part of UL data through the UL DPDCH. Also, due to the misjudgment, the UE deems that the DL DPCCH has not been and should not be terminated, such that the UE attempts to derive non-existing early termination indicators and TPC commands from the DL DPCCH that has been terminated. As a result, the UE may derive TPC commands by decoding DTX (discontinuous transmission) bits until the UE coincidentally decodes the DTX bits as a positive early termination indicator. During this period, the TPC commands that are derived by decoding the DTX bits could be improper for the UE. This may lead to the result that the UE improperly adjust its transmit power according to the improper command. This period is called an “UL abnormal TPC period.”

In another example shown by FIG. 3, the DL DPDCH is terminated according to positive early termination indictor sent by the UE in time slot 13 of the UL DPCCH. Then, the UE misjudges the negative early termination indictor sent by the Node B in time slot 15 of the DL DPCCH, as a positive one. Therefore, the UE terminates the UL DPDCH and UL DPCCH. However, as the Node B deems that it has not successfully decoded the UL data. Hence, the Node B attempts to derive non-existing early termination indicators and TPC commands from the UL DPCCH that has been terminated. As a result, the Node B may derive the improper TPC command by decoding the DTX bits, which leads to the result that the Node B improperly adjusts its transmit power according to the improper command. This is called a “DL abnormal TPC period.”

In the DL abnormal TPC period and the UL abnormal TPC period, the Node B and the UE may have abnormal transmit power control behaviors due to improper commands. This causes the Node B or the UE to have more or less transmit power than necessary, thereby reducing the system capacity or degrading the transmission efficiency in a next TTI.

### SUMMARY

In accordance with one embodiment of the present invention, a telecommunications method is provided. The telecommunications method is performed by a first telecommunications device, while a second telecommunications device tries to transmit a data block to the first telecommunications device. The method comprises: generating a determination result by determining whether a received part of the data block is successfully decoded prior to receiving all parts of the data block; and transmitting, to the second telecommunications device, an early termination indicator that is in response to the determination result, with a specific power that is higher than a power that is used to transmit at least one signal to the second telecommunication device.

In accordance with another embodiment of the present invention, a telecommunications method is provided. The telecommunications method is performed by a first telecommunications device, while a second telecommunications device tries to transmit a data block to the first telecommunications device. The method comprises: generating a determination result by determining whether a received part of the data block is successfully decoded prior to receiving all parts of the data block; and consecutively transmitting, to the second telecommunications device, a plurality of early termination indicators in response to the determination result indicating that the received part of the data block is successfully decoded by the first telecommunications device.

In accordance with still another embodiment of the present invention, a telecommunications method is provided. The telecommunications method is performed by a first telecommunications device while a second telecommunications device tries to transmit a first data block to the first telecommunications device. The method comprises: generating a determination result by determining whether a received part of the data block is successfully decoded prior to receiving all parts of the first data block; generating a termination signal according to the determination result and an early termination indicator sent from the second telecommunications device; and transmitting, to the second telecommunications device, the termination signal through a specific channel that is different from the a dedicated physical control channel between the first telecommunications device and the second telecommunications device.

In accordance with yet another embodiment of the present invention, a method is provided. The method is performed by a first telecommunications device while the first telecommunications device tries to transmit a data block to the second telecommunications device, comprising: determining whether to stopping adjusting a transmit power of the first telecommunications device according to a criterion; and stopping adjusting the transmit power when the criterion is satisfied.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates how the early termination mechanism works

FIG. 2 illustrates how the UL abnormal TPC period occurs.

FIG. 3 illustrates how the DL abnormal TPC period occurs.

FIG. 4 illustrates a first exemplary embodiment of reducing the probability of misjudging the early termination indicator according to present invention.

FIGS. 5A-5C illustrate a second exemplary embodiment of reducing the probability of misjudging the early termination indicator according to present invention.

FIG. 6 illustrates a first exemplary embodiment of alleviating the influence of the abnormal TPC period according to present invention.

FIG. 7 illustrates a second exemplary embodiment of alleviating the influence of the abnormal TPC period according to present invention.

FIG. 8 illustrates a third exemplary embodiment of alleviating the influence of the abnormal TPC period according to present invention.

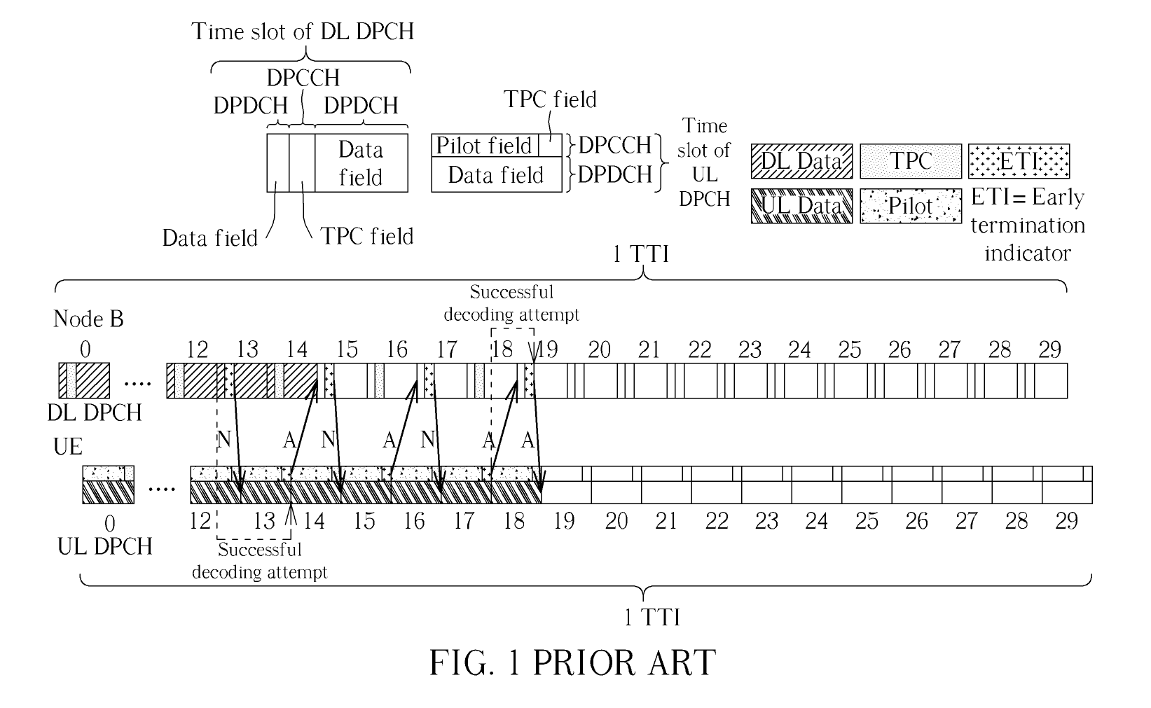

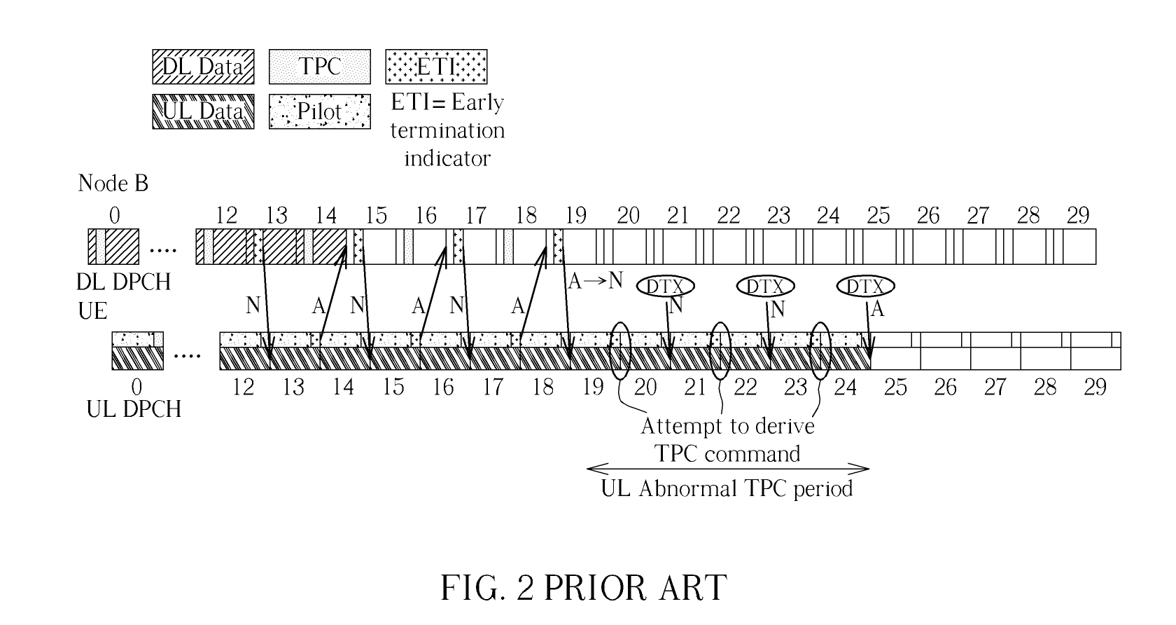

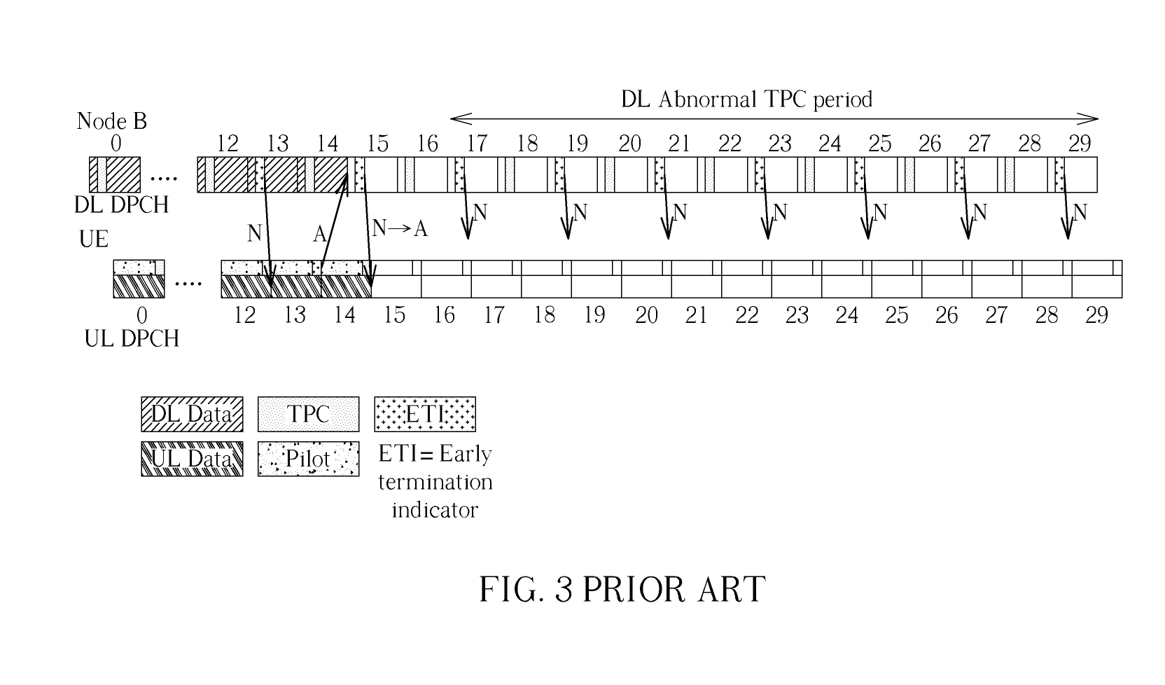

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

There are different types of approaches in the present invention to avoid the abnormal TPC behaviors, one of which is to reduce the probability of misjudging the early termination indicator, and the other of which is to alleviate the influence of the abnormal TPC period. These different types of approaches will be illustrated later in conjunction with different embodiments. However, please note that any approach in one embodiment may be further combined with the other approaches in other embodiments to more efficiently avoid the abnormal TPC behaviors.

### Embodiment I

The embodiment I of the present invention reduces the probability of misjudging the early termination indicator by improving signal intensity of the early termination indicator. For example, the early termination indicator can be transmitted with a transmit power more than other signals are commonly transmitted with. The signal-to-noise ratio regarding the transmission of the early termination indicator is therefore improved. Hence, the probability of misjudging the positive early termination indicator and the negative early termination indicator can be reduced due to more reliable signaling.

### Embodiment II

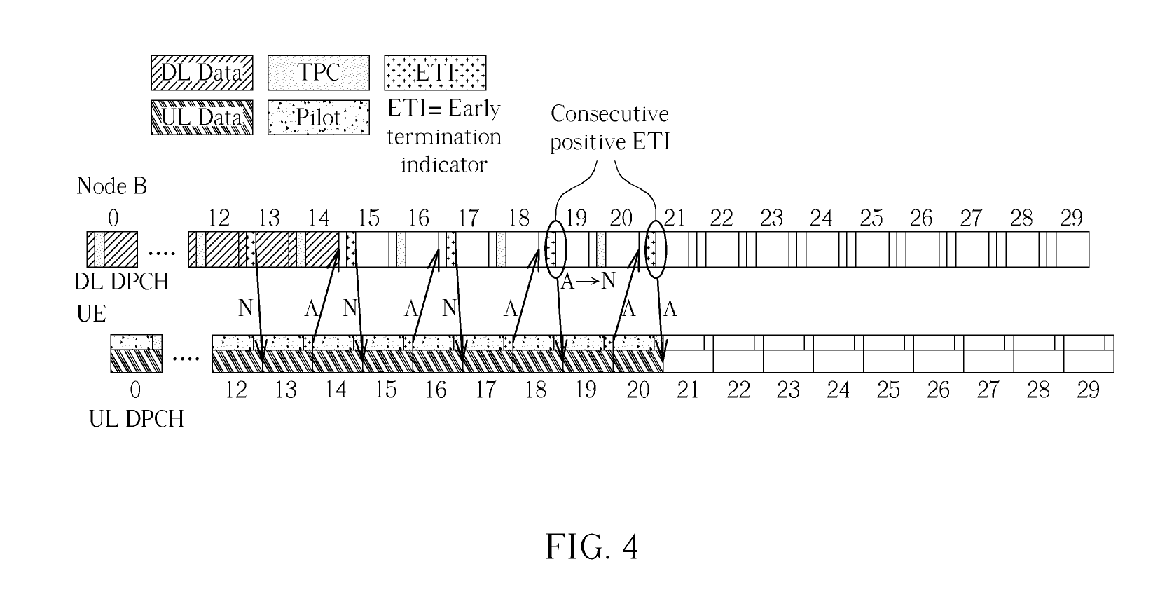

The embodiment II of the present invention reduces the probability of misjudging the positive early termination indicator by sending at least two consecutive positive early termination indicators. With reference to FIG. 4, in the time slot 19 of the DL DPCCH, the Node B sends a positive early termination indicator in response to a successful decoding attempt, to the UE for informing the UE of stopping transmit remaining part of UL data. However, the UE misjudges the positive early termination indicator as a negative early termination indicator. Therefore, the UE continually transmits to the Node B the remaining part of the UL data over the time slots 19-20 of the UL DPDCH, and also a TPC command in the time slot 20 of DPCCH. Then, in the time slot 21 of the DL DPCCH, the Node B again sends a positive early termination indicator, and the UE correctly recognizes it. Accordingly, the UE stops transmitting the remaining part of the UL data. Therefore, all of DPDCHs and DPCCHs of UL and DL can be terminated.

This embodiment reduces the probability of misjudgments by sending consecutive positive early termination indicators. The effect of the embodiment increases with the number of the consecutive positive early termination indicators that are sent. Assuming the probability of misjudging a positive early termination indicator as a negative early termination indicators is a, the probability of continually misjudging positive early termination indicators as negative early termination indicators will be a^{N}, (where N is the number of the positive early termination indicators that have been sent). Therefore, this approach significantly reduces the probability of misjudgments by the powers of the probability of the misjudgment. It should be noted that this approach can be applied to both the UE and the Node B while sending a positive early termination indicator in response to a successful decoding attempt.

### Embodiments IIIA-IIIC

The embodiments IIIA & IIIB of the present invention reduce the probability of misjudging the early termination indicator by using a different channel for transmitting a termination signal.

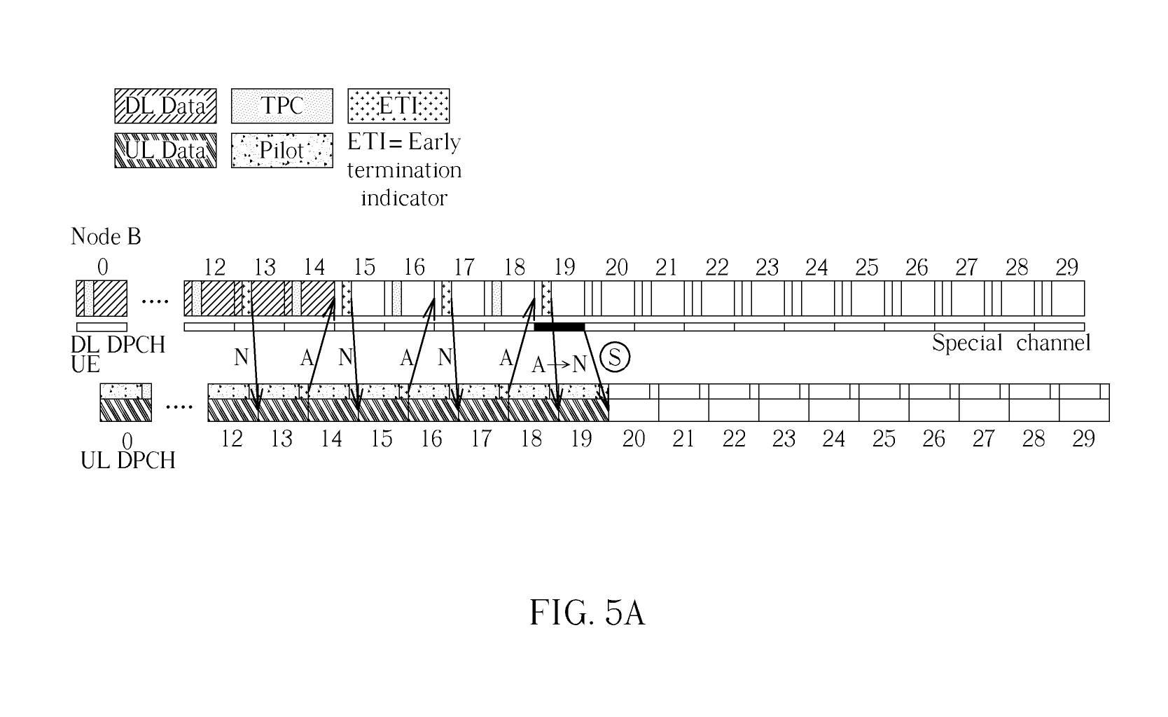

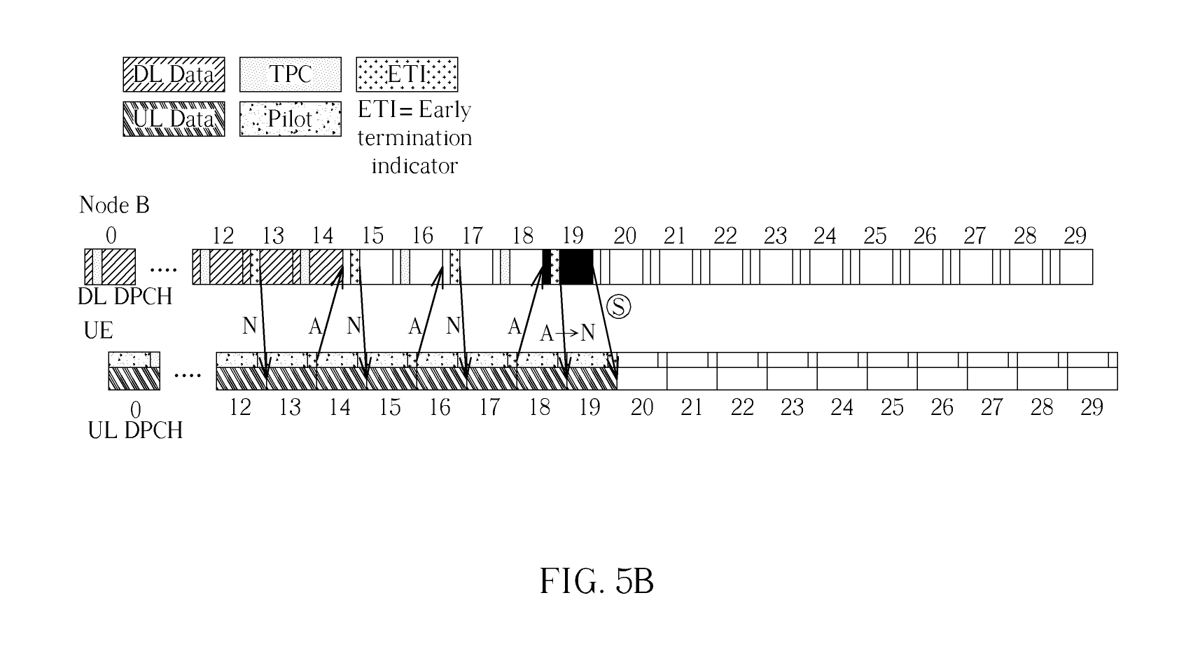

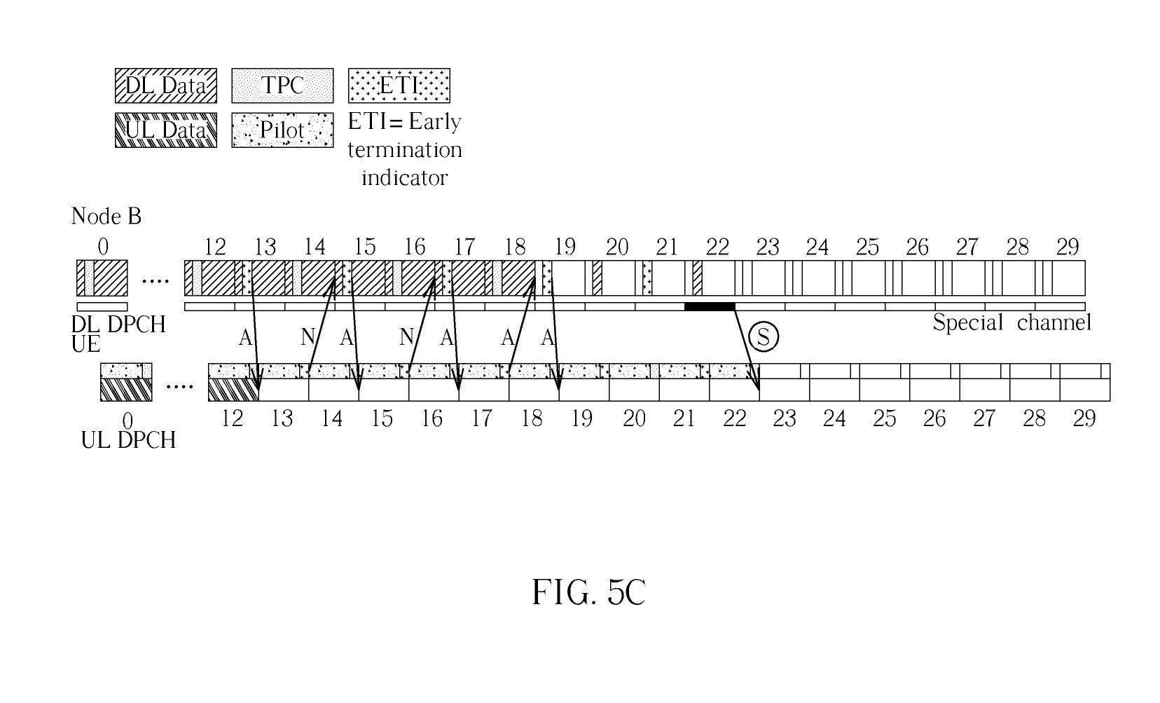

Please refer to FIG. 5A, in the time slot 13 of the UL DPCCH, the UE firstly sends a positive early termination indicator and the Node B correctly recognizes it. Then, in the time slot 19 of the DL DPCCH, the Node B sends a positive early termination indicator based on a successful decoding attempt, but the UE misjudges it. As the Node B realizes both the DL and the UL data have been successfully decoded, the Node B terminates the DL DPCCH. Due to misjudgment, the UE deems that the UL data has not been successfully decoded by the Node B, and thus continually transmits remaining part of the DL data. This may lead to the above-mentioned UL abnormal TPC period since the UE still attempt to derive the non-existing TPC command.

In the embodiment of FIG. 5A, in addition to sending a positive early termination indictor, a termination signal (designated with a capital letter “S”) is further transmitted by the Node B to inform the UE of the fact that both the DL data and the UL data have been successfully decoded, and the UL DPCCH as well as DPDCH should be also terminated. The termination signal is transmitted over a special channel that is different from the DPCCH. As the special channel could be better than the DPCCH in reliability, the probability of misjudging the termination signal may be lower than that of misjudging the early termination indicator.

In another case shown by FIG. 5B, as the Node B has stopped transmitting the DL data over the DL DPDCH due to the positive early termination indication sent by the UE, the termination signal is transmitted through the data field in the time slot 19 of the DL DPDCH, to inform UE of the fact that both the DL data and the UL data have successfully decoded and therefore the UL DPCCH and DPDCH should be terminated.

According to various embodiments of the present invention, the timing of transmitting the termination signal can be postponed. For example, in embodiment of the FIG. 5A, the Node B sends the termination signal right after receiving the positive early termination indicator around the time slot 19 of UL DPCCH. However, the Node B may send the termination signal much later in another embodiment. In the embodiment of FIG. 5B, apart from the time slot 19, the Node B may also send the termination signal in the time slots 22, 23, or other time slots of the DL DPDCH.

In the embodiment shown by FIG. 5C, the Node B firstly sends the UE a positive early termination indicator in the time slot 13 of the DL DPCCH due to a successful decoding attempt. Then, the UE also successfully decodes the received bits and sends a positive early termination indicator in the time slot 17 of the UL DPCCH. Conventionally, the UE should have terminated the UL DPCCH when the UE realizes that both of the UL data and the DL data have been successfully decoded. However, in this embodiment, the UE does not immediately terminate the UL DPCCH after its successful decoding. The UE still transmits control information through the UL DPCCH for a while, and terminates the UL DPCCH until the UE receives the termination signal that is sent from the Node B. That is, the termination of the UL DPCCH is actually determined by the Node B instead of the UE. Hence, in the approach of the termination of both the UL DPCCH and the DL DPCCH is determined by only the Node B. This is helpful when the misjudgment always occurs at certain side (Node B or UE). If the termination of the UL DPCCH and the DL DPCCH is determined by only one side, the probability of entering the abnormal TPC period can be reduced. Please note that, in other embodiments, the termination of both the UL DPCCH and the DL DPCCH may be only determined by UE.

Compared to the above embodiments, these embodiments have some differences. Firstly, these embodiments use different channels to send a signal instructing a signal receiver to terminate the DPCCH and DPDCH. For example, in the embodiment shown by FIG. 5A, the termination signal is sent through the special channel that is additionally created. In the embodiment shown by FIG. 5B, the termination signal is sent through the DPDCH. Both of them do not use the DPCCH to transmit the termination signal. Second, the termination of both the DL DPCCH and UL DPCCH is determined by only one side. The UE or the Node B will not terminate the DPCCH according to only the early termination indicator, and it is asked to refer to the termination signal sent by another side, and allowed to terminate the DPCCH when receiving the termination signal. This also helps to reduce the possibility of the misjudgment and the possibility of entering the abnormal TPC period.

### Embodiment IV

The embodiment IV of the present invention alleviates the influence of the abnormal TPC period by modifying the TPC mechanism.

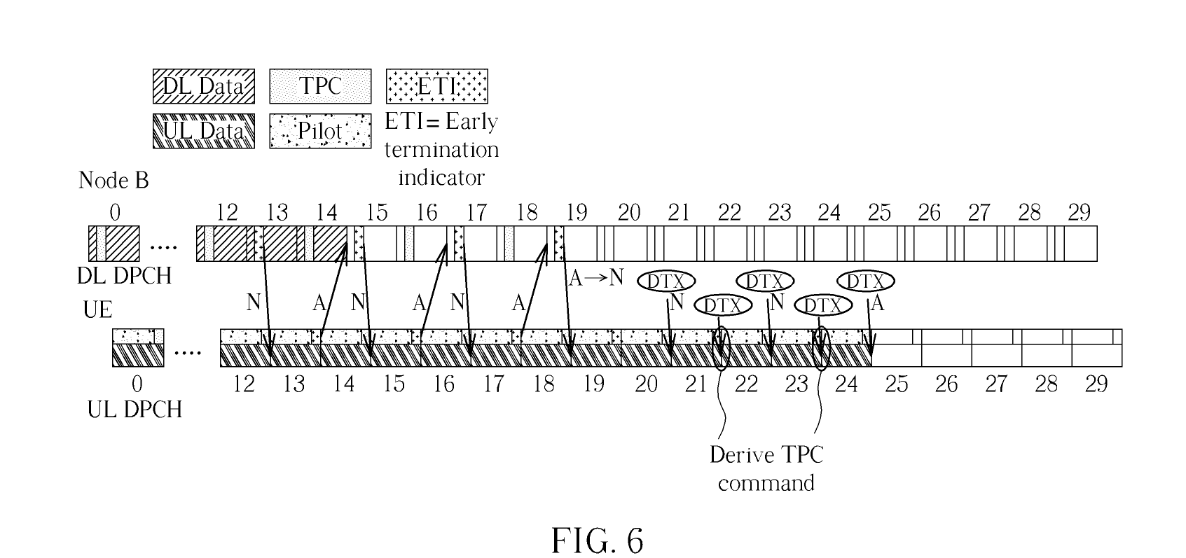

Please refer to FIG. 6, in the time slot 13 of the UL DPCCH, the UE sends a positive early termination indicator to the Node B based on a successful decoding attempt. The Node B correctly recognizes it and accordingly terminates the DL DPDCH. Then, in the time slot 19 of the DL DPCCH, the Node B sends a positive early termination indicator to the UE based on a successful decoding attempt, and also terminates the DL DPCCH. However, the UE misjudges the positive early termination indicator. Therefore, the UE continually transmits the remaining part of the UL data to the Node B and attempts to derive non-existing TPC commands and early termination indicators.

In this embodiment, even though the UE derives the TPC command by decoding the DTX bits in time slots 21 and 23, the UE will further refer to other parameters regarding signal power on the DPCCH to determine whether to adjust the transmit power according to the TPC command. In one embodiment, only when an estimated signal-to-noise ratio (SNR) or signal-to-interference-plus-noise ratio (SINR) regarding the DL DPCCH is found greater than a threshold, will the UE adjust the transmit power according to the TPC command. If the estimated SINR or SNR is not high enough, the UE will not adjust the transmit power according to the TPC command. Alternatively, the UE may not adjust the transmit power when it is found the estimated SINR suddenly drops. This is because if there is no TPC command is transmitted through the DL DPCCH, the signal power, the estimated SINR or the estimated SNR will be much lower than that in the condition where the TPC command is transmitted. Therefore, in this approach, the estimated SINR (or SNR) will be considered by the Node B or the UE to determine whether to adjust the transmit power according to a TPC command.

### Embodiment V

The embodiment V of the present invention alleviates the influence of the abnormal TPC period by modifying the TPC mechanism.

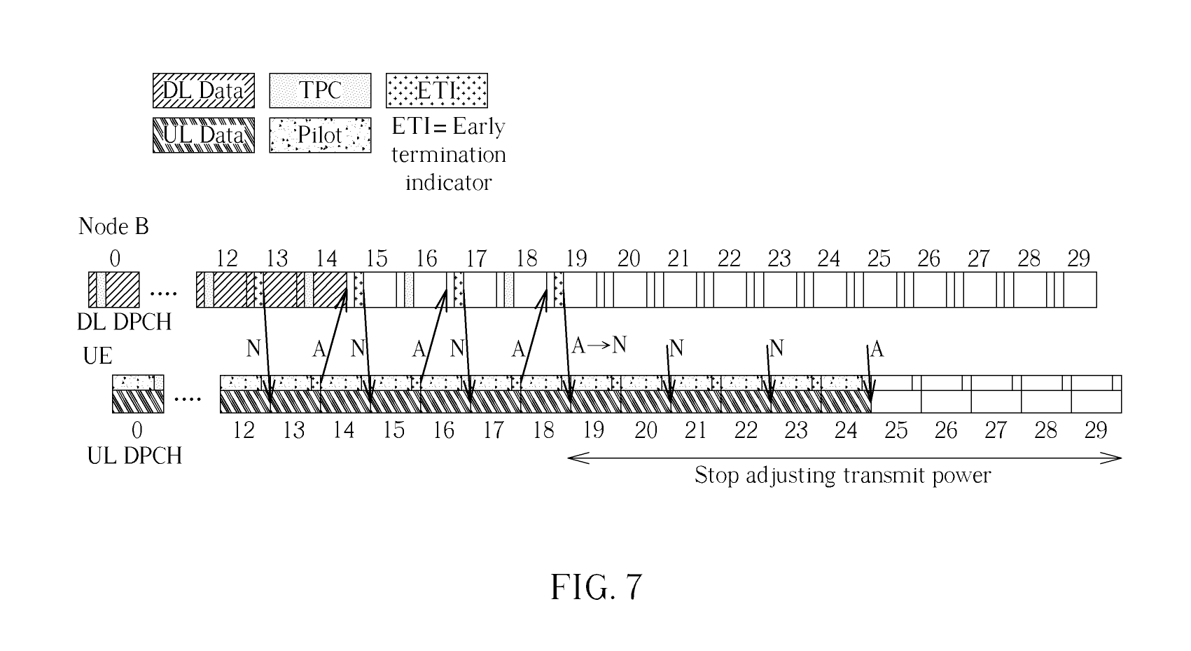

Please refer to FIG. 7, in the time slot 13 of the UL DPCCH, the UE sends a positive early termination indicator to the Node B based on a successful decoding attempt. The Node B correctly recognizes it and accordingly terminates the DL DPDCH. Then, in the time slot 19 of DL DPCCH, the Node B sends a positive early termination indicator based on a successful decoding attempt, and terminates the DL DPCCH. Unfortunately, the UE misjudges the positive early termination indicator as a negative early termination indicator. Therefore, the UE continually transmits the remaining part of the UL data to the Node B and attempts to derive non-existing TPC commands and early termination indicators.

In this embodiment, the Node B or the UE is asked to hold its transmit power within a certain period. The UE does not adjust its transmit power within a certain period even if the UE derives a TPC command by decoding the DTX bits. Therefore, the abnormal TPC period will not start, or can be shortened. The length of the period can be determined by referring to experimental data or channel quality. In the case of referring to experimental data, it is possible to estimate a period in which the early termination most likely to happen by collecting results of simulations on the actual data transmission period in a TTI. For example, if the UE usually successfully decodes received bits during the time slots 18-29 of a UL DPCH in a TTI, it is available to configure the UE to stop adjusting the transmit power after the time slot 18, or during time slots 18-29 of the UL DPCH. Therefore, even though the UE derives the improper TPC command during the time slots 18-29, the transmit power of the UE will not be adjusted. In the case of referring to the channel quality, the UE may be firstly configured to stop adjusting the transmit power after a certain timing or during a period. However, when the UL data transmission takes place, the UE could estimate the channel quality according to some information, for example, the number of times of retransmissions. If channel quality is better than expected, the UE will be configured to stop adjusting the transmit power earlier than the originally configured. On the other hand, if channel quality is worse than expected, the UE will be configured to stop adjusting the transmit power later than originally configured. With the period in which the transmit power is not adjusted, the abnormal TPC behaviors can be suppressed. Please note that according to various embodiments of the present invention, both UE and Node B could be configured to stop adjusting their transmit power within a certain period.

### Embodiment VI

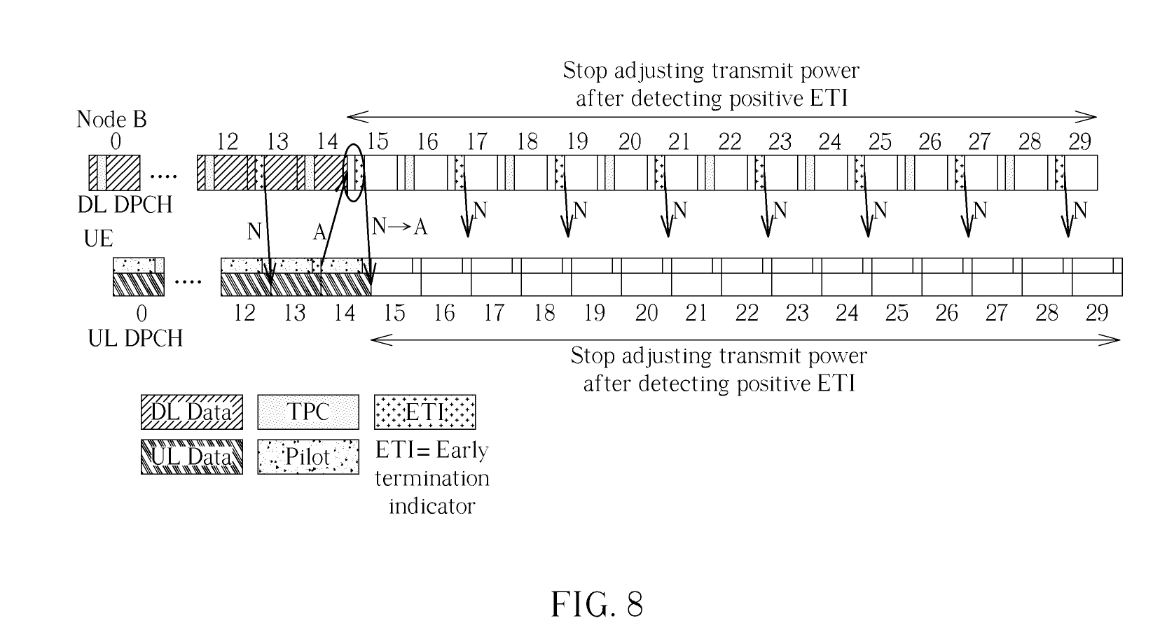

The embodiment VI of the present invention alleviates the influence of the abnormal TPC period by modifying the TPC mechanism. In this embodiment, as long as the Node B and/or the UE detects the positive early termination indictor (regardless of misjudgment or correct recognition), the Node B and/or the UE is asked to stop adjusting the transmit power. Please refer to FIG. 8, in the time slot 13 of the UL DPCCH, the UE sends the positive early termination indicator based on a successful decoding attempt, and the Node B correctly recognizes it. Due to the positive early termination indicator, the Node B stops adjusting its transmit power. Then, in the time slot 15 of the DL DPCCH, the Node B sends a negative early termination indicator, but the UE misjudges it as a positive one. However, the UE stops adjusting the transmit power in response to the detected positive early termination. Both the UE and the Node B do not have the chance to adjust its transmit power once they detects a positive early termination indicator. Hence, the abnormal TPC behaviors will not occur.

In summary, the above methods avoid the abnormal TPC behaviors by either reducing the probability of misjudging the early termination indicators or alleviating the influence of abnormal TPC behaviors. When the abnormal TPC behaviors is avoided by reducing the probability of misjudging the early termination indicators, the early termination indicator is sent to the telecommunications devices more reliably, and it is more easy for the telecommunications devices to correctly recognize the early termination indicator such that the transmission can be immediately terminated without deriving the abnormal TPC command. Also, it is achievable by sending a termination signal in a special channel having better channel quality such that the telecommunications devices can immediately terminates the transmission according to the termination signal. On the other hand, when the abnormal TPC behaviors is avoided by alleviating the influence of abnormal TPC behaviors, the TPC mechanism operated in the telecommunications devices is re-designed. The telecommunications devices are allowed to perform the power control operations only when specific criterion is satisfied. For example, only when the signal power regarding the control channel for sending the early termination indicator is high enough, the power control operations are performed. Alternatively, the telecommunications devices may be inhibited to perform the power control operations within certain period or once the positive early termination indicator is detected.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

An embodiment of the invention may include functionality that may be implemented as software executed by a processor, hardware circuits or structures, or a combination of both. The processor may be a general-purpose or dedicated processor. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A telecommunications method performed by a first telecommunications device while a second telecommunications device tries to transmit a data block to the first telecommunications device, the method comprising:
generating a determination result by determining whether a received part of the data block is successfully decoded prior to receiving all parts of the data block; and
transmitting, to the second telecommunications device, an early termination indicator in response to the determination result, with a specific power that is higher than a power that is used to transmit at least one signal to the second telecommunications device.

2. The telecommunications method of claim 1, wherein the first telecommunications device and the second telecommunications device are Wideband Code Division Multiple Access (WCDMA) telecommunications devices.

3. A telecommunications method performed by a first telecommunications device while a second telecommunications device tries to transmit a data block to the first telecommunications device, the method comprising:
generating a determination result by determining whether a received part of the data block is successfully decoded prior to receiving all parts of the data block; and
consecutively transmitting, to the second telecommunications device, a plurality of early termination indicators in response to the determination result indicating that the received part of the data block is successfully decoded by the first telecommunications device.

4. The telecommunications method of claim 3, wherein the first telecommunications device and the second telecommunications device are Wideband Code Division Multiple Access (WCDMA) telecommunications devices.

5. A telecommunications method performed by a first telecommunications device while a second telecommunications device tries to transmit a first data block to the first telecommunications device, the method comprising:
generating a determination result by determining whether a received part of the data block is successfully decoded prior to receiving all parts of the first data block;
generating a termination signal according to the determination result and an early termination indicator sent from the second telecommunications device; and
transmitting, to the second telecommunications device, the termination signal through a specific channel that is different from the a control channel between the first telecommunications device and the second telecommunications device.

6. The telecommunications method of claim 5, wherein the step of generating the termination signal comprises:
generating the termination signal for instructing the second telecommunications device to terminate at least one control channel when the early termination indicator sent from the second telecommunications device is a positive early termination indicator and the determination result indicates the received part of the data block is successfully decoded by the first telecommunications device;
wherein the first telecommunications device tries to transmit a second data block to the second telecommunications devices, and the positive early termination indicator is sent to the first telecommunications device when the second telecommunications devices successfully decodes a received part of the second data block prior to receiving all parts of the second data block.

7. The telecommunications method of claim 6, wherein the specific channel is a data channel that the first telecommunications device uses to transmit the second data block.

8. The telecommunications method of claim 5, wherein the first telecommunications device and the second telecommunications device are Wideband Code Division Multiple Access (WCDMA) telecommunications devices.

9. A method performed by a first telecommunications device while the first telecommunications device tries to transmit a data block to the second telecommunications device, comprising:
determining whether to stop adjusting a transmit power of the first telecommunications device according to a criterion when a transmit power command is derived; and
stopping adjusting the transmit power when the criterion is satisfied.

10. The method of claim 9, wherein the step of determining whether to stop adjusting the transmit power comprises:
determining to stop adjusting the transmit power of the first telecommunications device according to a parameter regarding signal power corresponding to a control channel between the first telecommunications device and the second telecommunications device.

11. The method of claim 10, wherein the step of determining to stop adjusting the transmit power of the first telecommunications device comprises:
determining to stop adjusting the transmit power when the parameter regarding the signal power is below a threshold.

12. The method of claim 10, wherein the parameter is signal-to-noise ratio (SNR) or signal-to-interference-plus-noise ratio (SINR).

13. The method of claim 9, wherein the step of determining whether to stop adjusting the transmit power comprises:
determining whether a positive early termination indicator is detected; and
stopping adjusting the transmit power when the positive early termination indicator is detected.

14. The method of claim 13, wherein the positive early termination indicator represents that a received part of the data block is successfully decoded by the second telecommunications device prior to receiving all parts of the data block.

15. The method of claim 13, wherein the positive early termination indicator is detected by the first telecommunications device misjudging a negative early termination indicator, wherein the negative early termination indicator represents that a received part of the data block is not successfully decoded by the second telecommunications device.

16. The method of claim 9, wherein the step of determining whether to stop adjusting the transmit power comprises:
determining whether to stop adjusting the transmit power according to a specific period; and
stopping adjusting the transmit power when entering the specific period.

17. The method of claim 16, wherein the specific period is predetermined.

18. The method of claim 16, wherein the specific period is determined according to channel quality of a data channel between the first telecommunications device and the second telecommunications device for transmitting the data block.

19. The method of claim 9, wherein the first telecommunications device and the second telecommunications devices are Wideband Code Division Multiple Access (WCDMA) telecommunications devices.
